(19) United States
(12) Patent Application Publication
(10) Pub. No.: US 2015/0195692 A1
(43) Pub. Date: Jul. 9, 2015

(54) METHOD AND APPARATUS FOR PROVIDING DEVICE RINGTONE COORDINATION

(71) Applicants: Lik Hang Chow, Beijing (CN); Wenwei Xue, Beijing (CN)

(72) Inventors: Lik Hang Chow, Beijing (CN); Wenwei Xue, Beijing (CN)

(73) Assignee: Nokia Corporation

(21) Appl. No.: 14/409,097

(22) PCT Filed: Jun. 26, 2012
(86) PCT No.: PCT/CN2012/077567

§ 371 Date: Dec. 18, 2014

(51) Int. Cl. H04W 4/16; H04M 3/02

(52) U.S. Cl. CPC H04W 4/16; H04M 3/02

(57) ABSTRACT

An approach is provided for providing device ringtone coordination. The approach involves determining a request for a playback of at least one ringtone at at least one device, wherein the playback is for a notification of at least one event. The approach also involves causing, at least in part, a coordination of the playback of the at least one ringtone among the at least one device, one or more other devices, or a combination thereof based, at least in part, on a determination of whether the one or more other devices are to be notified of the at least one event.

### BACKGROUND

Service providers and device manufacturers (e.g., wireless, cellular, etc.) are continually challenged to deliver value and convenience to consumers by, for example, providing compelling network services. One such service is the provisioning of ringtone alerts. Existing context-based ringtone services on mobile communication devices do not coordinate the ringtone alerts, such that the devices of the same user or different neighboring users may ring individually. When ringtones are played, they are heard not only by the mobile device owner, but also by people within a certain range (e.g., the neighbors). The ringtones interfere with one another, or even become confusing or annoying. Therefore, service providers and device manufacturers face significant challenges in coordinating and scheduling ringtones of neighboring devices.

### SOME EXAMPLE EMBODIMENTS

Therefore, there is a need for an approach for providing device ringtone coordination that better utilizes ringtones on mobile devices as media for event alerting, user communication, social expression, etc. This broadcast nature of coordinating and playing a ringtone on devices provides a pleasant event notification effect.

According to one embodiment, a method comprises determining a request for a playback of at least one ringtone at at least one device, wherein the playback is for a notification of at least one event. The method also comprises causing, at least in part, a coordination of the playback of the at least one ringtone among the at least one device, one or more other devices, or a combination thereof based, at least in part, on a determination of whether the one or more other devices are to be notified of the at least one event.

According to another embodiment, an apparatus comprises at least one processor, and at least one memory including computer program code for one or more computer programs, the at least one memory and the computer program code configured to, with the at least one processor, cause, at least in part, the apparatus to determine a request for a playback of at least one ringtone at at least one device, wherein the playback is for a notification of at least one event. The apparatus is also caused to cause, at least in part, a coordination of the playback of the at least one ringtone among the at least one device, one or more other devices, or a combination thereof based, at least in part, on a determination of whether the one or more other devices are to be notified of the at least one event.

According to another embodiment, a computer-readable storage medium carries one or more sequences of one or more instructions which, when executed by one or more processors, cause, at least in part, an apparatus to determine a request for a playback of at least one ringtone at at least one device, wherein the playback is for a notification of at least one event. The apparatus is also caused to cause, at least in part, a coordination of the playback of the at least one ringtone among the at least one device, one or more other devices, or a combination thereof based, at least in part, on a determination of whether the one or more other devices are to be notified of the at least one event.

According to another embodiment, an apparatus comprises means for determining a request for a playback of at least one ringtone at at least one device, wherein the playback is for a notification of at least one event. The apparatus also comprises means for causing, at least in part, a coordination of the playback of the at least one ringtone among the at least one device, one or more other devices, or a combination thereof based, at least in part, on a determination of whether the one or more other devices are to be notified of the at least one event.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-40 and 66-68.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing device ringtone coordination, according to one embodiment;

FIG. 2 is a diagram of the components of a coordination platform, according to one embodiment;

FIG. 3 is a flowchart of a process for determining a ringtone playback scheme for devices, according to one embodiment;

FIG. 4 is a flowchart of a process for responding to a ringtone coordination message by a neighboring device, according to one embodiment;

FIG. 5A is a system diagram utilizing the processes of FIGS. 3-4, according to one embodiment, FIG. 5B is a diagram depicting a conflict resolution process, according to one embodiment;

FIGS. 6A-6B are list views shown in user interfaces utilized in the processes of FIGS. 3-4, according to various embodiments;

FIGS. 7A-7B are map views shown in user interfaces utilized in the processes of FIGS. 3-4, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for providing device ringtone coordination are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “context information” refers to any information and/or context about a local environment as well as the users and communication devices within the local environment. The context information may refer to discrete context characteristics/data of a user and/or the user device, such as a date, time, location (e.g., points of interest), current event/activity, weather, a history of activities, etc. associated with the user. In particular, the contextual data elements may include location (where the user/UE is available, wherein the location based services is applicable, etc.), activity dates (the range of dates for which the user/UE and/or the location based services is available), event type (event information associated with the user/UE), time (of the event if the user/UE involves), applicable context (in which the location based services is applicable), and user preference information, etc. The context information may refer to user information and user preference data. Typical user information elements include a user identifier (e.g., telephone number), user device model (e.g., to identify device capabilities), age, nationality, language preferences, interest areas, login credentials (to access the listed information resources of external links).

By way of example, context information can be used to support applications for creating social networks, recommending events/friends/advertisements, determining presence, determining contexts associated with a device, advertising, searching for information, etc. Although various exemplary embodiments are described with respect to locating over an ad-hoc network user devices sharing same event alerts, it is contemplated that the approach described herein may be used within any type of communication system or network.

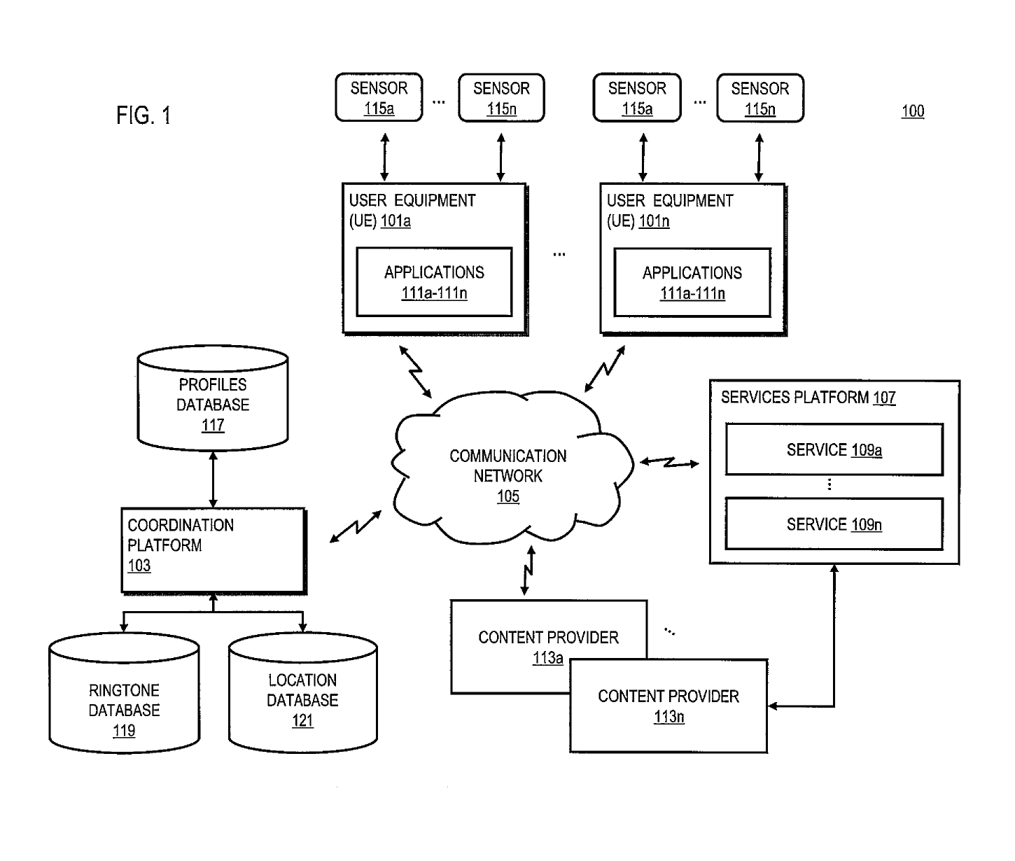

FIG. 1 is a diagram of a system capable of providing device ringtone coordination, according to one embodiment. The existing ringtone applications and services on mobile communication devices do not coordinate or schedule ringtones of neighboring devices. Specifically, existing ringtone applications and services mainly determine ringtones based on the context of a single application. Primarily, the single application may trigger a ringtone alert associated with a call, SMS, calendar item, email, IM message, SNS newsfeed the mobile device received. Thus, during the ringtone deployment, the contexts of other applications or the contexts of nearby users (e.g., neighbors) are not considered. Hence, when a ringtone is played in the neighborhood and is heard not only by the mobile device owner but also by people within a certain range of the mobile device owner, the ringtone is less effective because the ringtone may not be of interest to nearby people. Rather, the ringtones may be of interest to only the owner of the mobile device. However, several devices of the same owner may ring for the same event and annoy the owner. By way of example, multiple devices (e.g., a work phone, a personal phone, a tablet, a laptop, etc.) of the user ring one after another within a short time period to notify the same event (e.g., a calendar meeting, a group email, etc.), due to the common time asynchronization issue on these devices in real life. A user normally feels the first ringtone helpful, then may get bored by the second ringtone, and disturbed by the third ringtone or beyond.

Alternatively, the ringtones may be of interest only to the owner of the mobile device or some of the neighboring users. By way of example, Users A, B, C and D are working nearby in their own cubical, but only Users A, B and C will join the same meeting 15 minutes later. Due to time asynchronization of the ringtones, the meeting reminders ring at different times, e.g., User A's mobile rings first, User B's mobile rings after 7 seconds, and then User C's mobile rings after 16 seconds for the same meeting. User D, who is devoting himself to an urgent coding task, gets annoyed by the restless ringtones.

Further, in some instances, it is even more annoying when the ringtone is not even based on the context of the owner of the mobile phone but based on the caller (e.g., a telemarketer call, spam mails, etc.). Such ringtones may be a nuisance for the neighborhood.

To address this problem, a system 100 of FIG. 1 introduces the capability of providing device ringtone coordination. The system 100 provides the ability to coordinate the ringtones of user devices by sending a ringtone coordination message to other user devices for better coordination of ringtones on the devices. Rather than letting each device rings individually on its own, the system 100 forms neighborhood harmony among the multiple devices close to each other that need to ring to notify the same event. In one embodiment, the system 100 coordinates and harmonizes the ringing notifications (i.e. sound alerts) for the same event on nearby devices of one or more users.

The system 100 provides peer-to-peer (P2P) based local communication for information exchange among the devices, so as to coordinate the ringtones to, for example, ring together with the same tone to notify the same meeting for different users, to ring once by one of multiple devices belonging to a single user, etc. In one embodiment, the system 100 creates an ad hoc network for sharing context information, discovering user devices sharing the same event notifications by sending an anonymous flooding message (e.g., a ringtone coordination message) including a query over the ad-hoc network, forming communities/groups for coordinating ringtones, generating recommendations (e.g., friends, advertisements, etc.) to take advantage of the context information and the mesh network, maintaining the privacy and anonymity of users sharing context information, and prevents the proliferation of undesired messages (e.g., spam) over the network.

In one embodiment, a flooding message can make one hop (e.g., travel from one node to another node) per period. In one embodiment, a flooding message can make multiple hops by relaying the flooding message via several nodes. Multi-hop requires decisions of the distance and whether to continue forwarding via control signaling, causes time delay and battery power consumption.

In one embodiment, one or more ringtones are rendered in conjunction with one or more visual notifications, such as a pop-up event notification on a user interface of the device within a calendar application, a Tweet, a Facebook newsfeed, etc. The pop-up may contain a list of neighboring devices, a list of ringtone participating devices, or a combination thereof.

The visual notifications may include a map view depicted the locations of neighboring devices, the locations of ringtone participating devices, or a combination thereof. The map can be 2D, 3D, indoor/outdoor, etc. In another embodiment, the visual notifications include user profiles (e.g., organization (team, department, and company), interests, social relationships, etc.), ringtone participation status, etc. In yet another embodiment, the visual notifications include friend recommendations, event recommendations, advertisement recommendations, etc. The recommendations may be shared by users of all participating devices, or targeted to one or more particular users of the participating devices.

In one embodiment, the system 100 executes different alert types (e.g., audio, non-audio, pop-up, etc.) with different delay time periods. By way of example, visual notifications have no delay, then audio alerts are playback later with a delay time period.

In one embodiment, the system 100 selects in real-time one or more advertisements based on various contexts of a “ring-together neighborhood/range.” By way of example, the contexts include event metadata, user profiles, activities, shopping histories, user current locations, home/office locations, SNS friendships, etc. The recommended one or more advertisements may be displayed alongside with real-time statistics of the participating devices and/or the “ring-together neighborhood/range.” The system 100 may further display recommendation statistics, such as how many “ring-together” neighboring devices for the event have clicked/viewed the recommended one or more advertisements.

In one embodiment, the system 100 selects in real-time one or more friend recommendations based on various user contexts of the neighboring devices. By way of example, the system 100 recommends two users to become social network service (e.g., Facebook, Twitter, etc.) friends, if they are currently not friends but have been “ring-together neighbors” for a predetermined number of times.

In one embodiment, the system 100 supports a user to publish/recommend a “ring-together” event via social network services (e.g., Facebook newsfeed, Twitter tweet, etc.). By way of example, the user can publish a “call-for-weekend-hiking” group email to SNSs in order to attract more friends to participate.

When one or more ringtones are played on user devices, the system 100 may dynamically select an alert type as audible and/or visual advertisements based on the contexts of the device owners. The system 100 also automatically converts alert type and/or volume depending on individual context, sudden/urgent interruptions for important events, outreach to other groups, etc. By way example, when a group of doctors walk from a meeting room into an examination room, the system 100 converts ringtones from audio into vibration.

In one embodiment, the system 100 performs dynamic volume tuning for a group of devices to optimize the ringtones. The system 100 may recycle prior ringtone playback settings to increase efficiency.

In addition to reducing annoyance, the system 100 drives mutual attention/social activities of multiple users involved in the same event. The broadcast nature of coordinated ringtones on devices based on real-time multi-user contexts provides for a social effect. Interesting social activities may be driven/enhanced by simply coordinating/scheduling the “same-event-ring-notifications” across nearby devices of multiple users. By way of example, a plurality of fan devices ring together to cheer a player during a soccer game or to boo a pop singer in a concert. As another example, several friends' devices ring in turn or as choir to carry on a happy birthday song during a birthday party.

In one embodiment, the system 100 divides the participating devices into multiple groups based on various user contexts, such as location (indoor/outdoor), user profiles, SNS social relationships, etc. Different device operations (e.g., ringtones) could be scheduled for different groups. For example, both Team 1 and Team 2 in a research laboratory receive a massive group email, Ringtone 1 sounds for all devices belonging to users in Team 1, while Ringtone 2 sound for devices of Team 2.

The ringtones may be created by extracting segments from source audio or video files, such as pop songs, classic music, natural sounds, user-generated content (e.g., user's own voice), advertiser-generated content, etc. By way of example, ringtones may be deployed to mobile phones using a combination of mobile messaging, such as SMS and MMS, and internet technologies such as WAP.

The system 100 can implemented as an OS-level middleware module running on mobile devices. The middleware module provides APIs as part of mobile OS SDK for other services/apps to, e.g., register different kinds of app-specific event notifications that the developers would like to be coordinated among multiple nearby devices of one or more users, or select event-specific ringtones and/or ringtone playing manners upon events. The middleware can also collect the ring together statistics for business intelligence use, such as recommendations.

In one embodiment, the system 100 does not require user intervention. All detailed scheduling/communication operations are transparent to the users. A user may optionally set a few high-level service parameters, as preferred. By way of example, the user may disable the “ring-together” function for a particular kind of event notification due to a privacy concern. As another example, the user may change the delay time period for one kind of event notification, to tailor a ringtone/ring playing manner.

As shown in FIG. 1, the system 100 comprises user equipment (UE) 101a-101n (collectively referred to as UE 101) that may include or be associated with applications 111a-111n (collectively referred to as applications 111) and sensors 115a-115n (collectively referred to as sensors 115).

The applications 111 may be any type of application that is executable at the UE 101. By way of example, the applications 111 may be media (e.g., audio, video, images, etc.) player applications, social networking applications, navigational applications, calendar applications, content (e.g., audio, video, images, etc.) provisioning services, etc. In one embodiment, the applications 111 may generate contextual information regarding the UE 101, or information that may be processed to determine contextual information associated with the UE 101. By way of example, an application may determine location information associated with the UE 101 that may be processed as contextual information. In one embodiment, one of the applications 111a at the UE 101 may act as a client for the coordination platform 103 and perform one or more functions associated with the functions of the coordination platform 103. By way of example, the client application 111a may update the context information of the UE 101 at the coordination platform 103, may request one or more ringtones before a ringtone is played at the UE 101, or a combination thereof.

In one embodiment, the coordination platform 103 sends a request to the UE 101a to update the contextual information (e.g., a location). For example, when the user of UE 101 powers up the UE 101, the UE 101 listens for a system identification code on the control channel. The control channel is a special frequency that the phone and base station use to talk to one another about things like call set-up and channel changing. When the coordination platform 103 receives the system identification code, the coordination platform 103 compares the system identification code to the code programmed in, for example, the profiles database 117. Along with the system identification code, the UE 101 also transmits a registration request, and the coordination platform 103 keeps track of the user's phone location in a database. The coordination platform 103 gets the call and attempts to find the user's phone. It then picks a frequency pair and communicates with the user's phone over the control channel to tell it which frequencies to use, and once the UE 101 and the tower switch on those frequencies, the call is connected. The UE 101 sends the updated contextual information, if any, to the coordination platform 103.

The sensors 115 may be built in the UE 101 or attached/connected to the UE 101 with a wire or wirelessly. The sensors 115 may be any type of sensor. In one embodiment, the sensors 115 may include one or more sensors that are able to determine contextual information associated with the UE 101, the users of the UE 101, or a combination thereof. By way of example, the sensors 115 may include location sensors (e.g., GPS), light sensors, moisture sensors, pressure sensors, audio sensors (e.g., microphone), etc. In one embodiment, one or more receivers for different short-range communications, such as Bluetooth, WiFi, etc., may be considered sensors that can determine the number and type of neighboring devices within the vicinity of a UE 101.

The UE 101 has connectivity to a coordination platform 103, a services platform 107 including services 109a-109n (collectively referred to as services 109) and content providers 113a-113n (collectively referred as content providers 113) via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

The services platform 107 including the services 109 may include any type of service. By way of example, the services 109 may include social networking services, content (e.g., audio, video, images, etc.) provisioning services, navigational services, application services, storage services, contextual information determination services, location based services, information (e.g., weather, news, etc.) based services, etc. The contextual information determination services may determine contextual information associated with the UE 101 to supplement or aid in the contextual information acquired by the applications 111 and/or the sensors 115. The services 109 may interact with the UE 101, the coordination platform 103, and the content providers 113.

By way of example, a social networking service 109a is an online service that reflects social networks or social relations among people that may, for example, share relationships, interests and/or activities. A social networking service 109a essentially consists of a representation of each user (often a profile), his/her social links, and a variety of additional information. The social networking service 109a allows users to share ideas, activities, events and interests within their individual networks, and provides for data portability. The social networking service 109a may assist in providing the coordination platform 103 with contextual information associated with user profile information, user preference information, location information, temporal information, activity information or a combination.

The content providers 113 may provide content to the UE 101, the coordination platform 103 and the services 109 of the services platform 107. The content provided may be any type of content, such as audio content (e.g., ringtones), video content, image content, etc. In one embodiment, the content providers 113 may provide content information that may supplement content information determined by one or more of the applications 111, the sensors 115, or a combination thereof. By way of example, the content providers 113 may provide information content that may include contextual information (e.g., user preferences, social networks, weather information, news information, etc.) that may be processed or aid in the processing of contextual information associated with one or more of the UE 101. In one embodiment, the content providers 113 may also store content associated with the UE 101, the coordination platform 103 and/or the services 109. In one embodiment, the content providers 113 may manage access to a central repository of data, and offer a consistent, standard interface to data, such as a repository of ringtones and/or audio advertisements.

The coordination platform 103 performs the functions of providing device ringtone coordination. Although illustrated as a separate element of the system 100 in FIG. 1, the coordination platform 103, or one or more functions performed by the coordination platform 103, may be embodied in one or more other elements of the system 100, such as in one or more applications 111 on the UE 101 or one or more services 109. Associated with the coordination platform 103 are a profiles database 117, a ringtone database 119, and a location database 121. The profiles database 117 may includes profile information associated with the users, the client devices (e.g., UE 101) of the coordination platform 103, or a combination thereof. The ringtone database 119 may include the ringtones that are selected by the coordination platform 103 and transmitted to the client devices. The location database 121 may include information pertaining to the locations of the client devices and information regarding neighborhoods based on groups of client devices and their corresponding locations. In one embodiment, the location information of the client devices may be included within the profiles database 117 rather than in a separate database.

The coordination platform 103 may determine one or more sounds (e.g., ringtones, alarms, notifications, etc.) that are played by one or more mobile devices upon the occurrence of an event associated with the one or more mobile devices and/or the users of the devices. The event may include, for example, a meeting, a social gathering, a concert, a sports practice, a parade, the device receiving an incoming communication (e.g., call, SMS message, MMS message, email, etc.), upon an alarm activating, upon a reminder occurring (e.g., an appointment, a calendar event, etc.), or the like. Upon the occurrence of the event, the coordination platform 103 may dynamically select one or more sounds and/or one or more visual notifications based on the contextual information associated with the devices and/or the owners of the devices in the vicinity.

The coordination platform 103 may recommend ringtones, friends, events, advertisements, etc. for users associated with the coordination platform 103. The recommendations may be based on user profiles, such as interests, shopping history, home/office locations, social networks, etc. The recommendations may be dynamically updated as the coordination platform 103 receives updates to the user profiles. This information may be stored for each user within the profiles database 117 associated with the coordination platform 103, as illustrated in FIG. 1. In one embodiment, the recommendations may be requested or ordered according to the users' preferences.

Additionally, users associated with the coordination platform 103 may periodically update their locations with the coordination platform 103 such that the coordination platform 103 is aware of the positions of the users. The positions of the users may be determined and updated based on the location of the users' associated devices and based on, for example, one or more applications 111 updating the location information at the coordination platform 103. In one embodiment, a service 109 may alternatively update the locations of the users at the coordination platform 103. This information may be stored in the location database 121 associated with the coordination platform 103, as illustrated in FIG. 1. Based on the location information, the coordination platform 103 can determine neighborhood information, or groups of users that are within a certain vicinity of another user and/or device that are associated with the coordination platform 103. The locations of the devices may be dynamic, such that the neighborhoods are also dynamic. The coordination platform 103 includes the ability to determine neighborhoods and the associated users continuously in real time based on the location information received from the UE 101 according to certain update intervals. In one embodiment, the coordination platform 103 may control the update intervals.

The coordination platform 103 determines a ringtone playback range/neighborhood based on the location information associated with the devices. In one embodiment, the devices may determine the location information according to, for example, GPS, cell ID, WiFi, Bluetooth, etc. based on being in short-range communication with other devices and send this information to the coordination platform 103. Under this approach, a peer-to-peer method may be employed to determine the neighborhoods. Further, service users that are near to each other may coordinate their ringtones. In such an embodiment, the devices may store information regarding the preferred ringtones. Prior to playing a ringtone, a device may broadcast a ringtone coordination message to all nearby devices using, for example, short-range data communication or an audio-based broadcasting. The audio-based broadcasting may be associated with an inaudible probing audio wave that is broadcasted and detected by nearby devices (e.g., using the microphones). According to this approach, this ability of the other devices to detect the inaudible probing audio wave concurrently determines a subsequent ringtone coverage area.

In one embodiment, the ringtone coordination message includes one or more event types, one or more event signatures/IDs, a delay time period for playing ringtones under coordination, etc. In another embodiment, the ringtone coordination message further includes a ringtone identifier for the event preferred by the broadcasting device (e.g., “Happy Birthday To You”), a ringtone scheduling scheme preferred by the broadcasting device (e.g., ring together, ring like a choir), etc.

In one embodiment, the event types are defined by application names and/or IDs identifying the mobile application (e.g., calendar, email, SMS, social network, Twitter, instant messenger, online chat, etc.) that the event is originated from.

In one embodiment, the event signatures/IDs are generated by concatenating and hashing various textual metadata associated with the event (e.g., subject/body/location/time/ . . . of a calendar item, title/sender/receivers/ . . . of a group email, etc.). The hash value is difficult to decode to obtain the original event metadata thus increases privacy protection. In addition, the hash value is much shorter than the metadata associated with the event thereby reducing the transmission time for the neighboring devices to receive ringtone coordination messages and execute ringtone playback.

The broadcasting device can transmit such a single numeric hash value instead of a long event metadata text, so as to save communication cost and reduce the transmission time.

In one embodiment, the delay time period for playing ringtones under coordination is a default value set by the system 100 for the participating devices to play ringtone after passing the delay time period (e.g., since receiving the ringtone coordination message). In another embodiment, the delay time period is set by a device owner and/or a ringtone coordination service subscriber. Various delay time periods can be set for different types of events.

In one embodiment, the delay time period is set as an absolute time point (e.g. 2012-04-10 18:23:45) by the broadcasting device, assuming the clocks of the participating devices are synchronized. In another embodiment, the delay time period is set as a time period passing since a participating device receives the ringtone coordination message. This is beneficial when the clocks of the participating devices are not synchronized.

Once a neighboring device receives the broadcast ringtone coordination message, the neighboring device may examine all coming local events that are not yet but to be notified via ringtones within the delay time period specified in the ringtone coordination message.

In one embodiment, the neighboring device examines the coming local events one by one in a descendant time order. In another embodiment, the neighboring device examines the coming local events according to a priority based upon, e.g., event type, alert type (e.g., audio, non-audio, pop-up, etc.), playback mode (e.g., normal, vibrate, mute, etc.), or a combination thereof.

For examining a specific local event, the neighboring device computes its hash value and compares this value with the hash value received in the ringtone coordination message. The hash function is built-in within the ringtone coordination service and uniform on all devices subscribed to the service. If a match is found, the neighboring device responds to the broadcasting device with an acknowledgement message, and flushes the local, pre-defined ringing time to be the delay time period T_{d} for the associated local event (e.g., a meeting) to be ringed under coordination (e.g., ringed together with the broadcasting device after T_{d}).

The acknowledgement message may include context information of the neighboring device, the event, a ringtone identifier for the event preferred by the user of the neighboring device, etc. Upon determining the participating devices, a client application 111a at the broadcasting device may determine, based upon the context information, a ringtone scheme that has an overall best effect.

In one embodiment, the client application 111a may process the preferred ringtone identifier and/or the context information of the neighboring device as well as its own preferred ringtone identifier and/or the context information to select a ringtone playback scheme for the devices. In another embodiment, the broadcasting device transmits the ringtone identifiers and context information to the coordination platform 103 for the coordination platform 103 to determine and select a ringtone playback scheme for the devices. Once the ringtone playback scheme is determined, the coordination platform 103 may transmit a ringtone scheme message to the devices.

In one embodiment, the neighboring device does not examine any subsequent event during the time window T_{d}. In another embodiment, the neighboring device continues examining one or more subsequent events during the time window T_{d}. In yet another embodiment, the neighboring device does not ring for any precedent event during the time window T_{d}. In yet another embodiment, the neighboring device ring for one or more precedent events during the time window T_{d}.

In one embodiment, the broadcast time of the ringtone coordination message, the local computation time on event hashing and matching are neglected. In another embodiment, both these two times are estimated and amortized on T_{d} by the neighboring device for more precisely coordinating the ringtones.

In another embodiment, the broadcasting device sends a request for a ringtone scheme to the coordination platform 103. Upon receiving the request from the broadcasting device, the coordination platform 103 may dynamically determine a ringtone playback scheme for the devices based upon context information of the participating devices. By way of example, the coordination platform 103 may pick the ringtone that appears in the preferred sets of most of the users. By way of another example, the coordination platform 103 may aggregate the weights of each ringtone appearing in the preferred sets of a few users and pick the ringtone with the largest weight. After determining the ringtone scheme, the coordination platform 103 sends the ringtone scheme to the broadcasting device.

In one embodiment, the context information of the participating devices is included in the request from the broadcasting device. In another embodiment, the coordination platform 103 may determine contextual information associated with a device and at least one neighboring device from other information sources. The contextual information may include, for example, the location of the device and the at least one neighboring device. The contextual information may also include, for example, the current background noise or environmental noise within the vicinity of the device and the at least one neighboring device. The coordination platform 103 further processes the contextual information to determine the ringtone playback scheme for the devices. Because the coordination platform 103 takes into account the device and the at least one neighboring device when determining the ringtone playback scheme, the ringtone playback scheme may be better appreciated and act on in the event that the ringtones are, for example, coordinated.

In one embodiment, the broadcasting device may include current ringtone volume levels of itself and the participating devices in the request for the coordination platform 103 to adjust the levels. In another embodiment, the broadcasting device may send the current ringtone volume levels if there is a threshold change since the previous request. Based on the ringtone volume levels in the request, the coordination platform 103 may determine the effective spatial coverage of the ringtone playing at the specific time based on, for example, the damping of sound levels with distance. The coordination platform 103 may then determine ringtone volume levels for the devices.

To provide device ringtone coordination, the coordination platform 103 determines the ringtone playback capability information associated with the device and processes the ringtone playback capability information to determine the ringtone playback range. The ringtone playback range is, for example, the range at which the ringtone will be heard when played by the device. One factor that can affect the ringtone playback range may be, for example, the volume that the device can play a ringtone. Thus, the ringtone playback capability information associated with the device may include how loud the device can playback a ringtone and the resulting range, which may be determined based on known sound damping levels in relation to distance. Based on this processing, the coordination platform 103 can determine a range within which to determine whether there are neighboring devices.

Another factor that can affect the ringtone playback capability is the ambient noise that is present in the location of the participating device. The louder the ambient noise, the shorter the distance the sound of the ringtone playback will carry. Thus, in one embodiment, the coordination platform 103 can process the contextual information to determine ambient noise information and base the ringtone playback range on the ambient noise information. The louder the ambient noise, the smaller the ringtone playback range and the smaller the area the coordination platform 103 may consider when determining neighboring devices.

In one embodiment, the coordination platform 103 also may process contextual information to rank the neighboring devices based on physical proximity, social proximity, or both. By way of example, physical proximity is determined based on the nearness in location to the broadcasting device that requests the ringtone playback scheme from the coordination platform 103. By way of example, social proximity is determined based on the proximity of neighboring devices associated with user profile information, user preference information, location information, temporal information, activity information, or a combination. Upon determining the ranking, the coordination platform 103 may determine one or more weighting values for the one or more neighboring devices based on the ranking and process the contextual information to determine the ringtone playback scheme based on the ranking.

In one embodiment, the coordination platform 103 may monitor the contextual information of the participating devices to adjust the ringtone playback scheme. The monitoring may be performed continuously, periodically, according to a schedule, on demand, or a combination thereof. By way of example, the coordination platform 103 may monitor for changes in the locations of the participating devices and continuously adapt the ringtone playback scheme based on the continuously determined locations of the participating devices.

In one embodiment, the coordination platform 103 may process the contextual information to recommend friends, events, and advertisements for one or more of the participating devices. By way of example, the location of a device and neighboring devices may be located within a certain proximity to a retail establishment. The retail establishment may be associated with the coordination platform 103 to provide advertisements of the retail establishment together with the provided ringtones.

In one embodiment, the coordination platform 103 may cause the user's device that is playing the ringtone to cause one or more additional interactions, such as vibrate. Thus, the vibration of the device in addition to hearing the ringtone may cause the owner of the device to be more aware of the event. In one embodiment, the coordination platform 103 may cause a provided ringtone to be mixed with another sound, such as a native/original ringtone of the user's device. The coordination platform 103 may combine the native ringtone and the provided ringtone using audio processing techniques with the native ringtone being played in the background and with the provided ringtone being played in the foreground. The coordination platform 103 may also, or in the alternative, perform time interleaving such that the native ringtone is played for a time period T₁ followed by the provided ringtone for a time period T₂.

By way of example, the UE 101, the coordination platform 103, the services platform 107 and the content providers 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

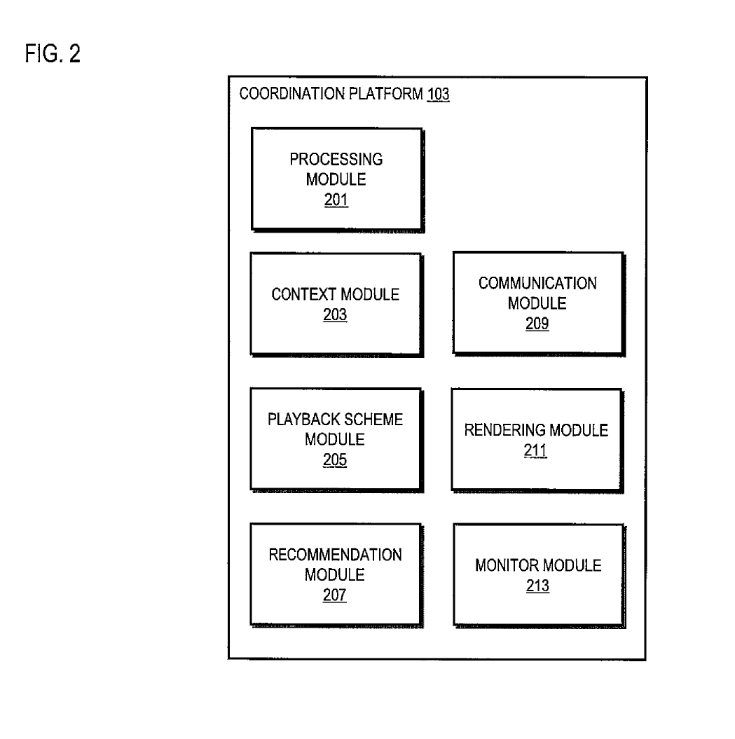

FIG. 2 is a diagram of the components of a coordination platform 103, according to one embodiment. By way of example, the coordination platform 103 includes one or more components for providing device ringtone coordination. As discussed above, it is contemplated that the functions of these components may be combined in one or more components or performed by other components of equivalent functionality. In this embodiment, the coordination platform 103 includes a processing module 201, a context module 203, a playback scheme module 205, a recommendation module 207, a communication module 209, a rendering module 211, and a monitor module 213.

The processing module 201 enables the coordination platform 103 to process the contextual information of a broadcasting device to determine ringtone/alert events in the broadcasting device, and assigns IDs to each of the event alerts. The processing module 201 assembles a ringtone coordination message to one or more neighboring devices to figure out which of those devices have the same ringtone/alert events as the broadcasting device. The ringtone coordination message includes at least a broadcasting device ID, an event alert ID, and a playback delay time period T_{d}.

For a pre-scheduled event (e.g., a calendar item), T_{d} could be set as a small value (e.g., a few seconds). Pre-scheduled events usually have the requirement of real-time notification. For a “maybe arriving” event (e.g., a group email/SMS/IM/SNS newsfeed), the same event may or may not have been available/arrived on a neighbor device. By way of example, a group email may have been received by the broadcasting device, yet not have been received by a neighboring device. This is because a group mail has mail server and network transmission delay, so it is usually not delivered to and received by all of its recipients at the same time. In this case, T_{d} should be set as a relatively large value (e.g., tens of seconds, even a few minutes).

The processing module 201 then analyzes acknowledge messages (in response to the ringtone coordination messages) from the neighboring devices and determines participating devices and forward the information to the playback scheme module 205.

In one embodiment, the processing module 201 screens/filters the participating devices based on ringtone playback range. For example, when an acknowledge messages is received from a neighboring device, the processing module 201 processes the ringtone playback capability information of the neighboring device to determine the ringtone playback range of the neighboring device (to be audible/perceived by another device). If the ringtone playback range is longer than the distance between the broadcasting device and the neighboring device, the neighboring device is included in the ringtone playback scheme. If the ringtone playback range is shorter than the distance between the broadcasting device and the neighboring device, the neighboring device is excluded from the ringtone playback scheme.

In another embodiment, the processing module 201 obtains information from the location database 121 regarding available neighboring devices who fall within the spatial coverage of the ringtone playback range of the broadcasting device, and sends out a ringtone coordination message only to those neighboring devices within the spatial coverage.

When receiving a ringtone coordination message from a neighboring device, the processing module 201 decodes an event alert hash value extracted from the ringtone coordination message, and compares a decoded event alert ID with an internal event alert ID. If a match is found, the processing module 201 composes an acknowledge message and sends the message to the broadcasting device. The acknowledge message includes at least the broadcasting device ID, the event alert ID, and a participating device ID.

If no match is found, the processing module 201 may simply stops processing, or composes an acknowledge message to send to the broadcasting device to report that it does not have the same event alert.

When receiving two or more ringtone coordination messages from neighboring devices for the same event alert, the processing module 201 selects one of the ringtone coordination messages to respond based upon one or more conflict resolution policies. As a policy, a neighboring device will not respond to duplicate ringtone coordination message for the same event.

In one embodiment, the processing module 201 selects and responds to the ringtone coordination message with the largest value of the delay time period T_{d}, so that the participating device has more time to execute the ringtone playback scheme. As another example, the processing module 201 selects and responds to the ringtone coordination message with the smallest value of the delay time period T_{d}, so that the participating device has more time to respond to subsequent ringtone coordination messages.

In one embodiment, the processing module 201 selects and responds to the ringtone coordination message with the highest priority based upon the context of the senders or the context of the event. By way of example, the processing module 201 selects and responds to the ringtone coordination message from the CEO rather than the manager, colleagues, etc.

The context module 203 enables the coordination platform 103 to determine the contextual information associated with a device and a neighboring device by collecting or determining contextual information associated with the device and the neighboring device. In one embodiment, the context module 203 may determine contextual information from the profile database 117, the applications 111 executed at the UE 101, the sensors 115 associated with the UE 101, and/or one or more services 109 on the services platform 107. As the UE 101 sends a request for ringtone playback to the coordination platform 103, the context module 203 provides the coordination platform 103 with contextual information. The contextual information provided to the coordination platform 103 can be, for example, user profile information, user preference information, temporal information, location information, activity information or a combination.

For example, the coordination platform 103 selects the ringtones on the basis of user preference. In one embodiment, the context module 203 may track the exchange of audio files for particular users. In this manner, the statistical data that is obtained may be used for any suitable purpose, including the selection of ringtones. The data may include, for example but not limited to, popularity of particular ringtones, popularity of ringtones as a function of the age of the user, popularity of ringtones as a function of the time of day, popularity of ringtones as a function of the region of the country, popularity of ringtones as a function of the sex of the user, popularity of ringtones as a function of the demographics of the user, popularity of ringtones as a function of the income of the user, popularity of ringtones as a function of the duration of use by the user, popularity of ringtones as a function of the work culture of the user, popularity of ringtones as a function of the genre of the corresponding audio files, etc.

The context module 203 determines the ringtone playback capability of the broadcasting device and the neighborhood devices. As the neighboring users change, the context module 203 determines the neighboring users by determining the dynamic neighborhood range. In one embodiment, the context module 203 determines the dynamic neighborhood range by processing microphone volume levels associated with ringtone coordination messages.

The playback scheme module 205 enables the coordination platform 103 to process the acknowledgement messages and/or the contextual information to determine: (a) ringtone participating devices, (b) rankings/grouping of neighboring devices based on physical and social proximity, (c) a ringtone playback scheme including one or more ringtones for the participating devices to playback based on, e.g., the preference and popularity amongst the users of UE 101, device ringtone playback capabilities, ambient noise information, etc. The playback scheme module 205 may include one or more algorithms that are executed in performing the processing. The parameters and attributes for each participating device can be sent to the devices via an updated ringtone coordination message.

The update ringtone coordination message may include (a) ringtone playback information of timing, content, one or more volumes, one or more lengths, one or more frequencies, one or more playback delay time periods (e.g., T_{d}), one or more alert types (e.g., audio, non-audio, pop-up, etc.), one or more playback modes (e.g., normal, vibrate, mute, etc.), or a combination thereof, of the playback; (b) location information of the at least one device, the one or more neighboring devices, or a combination thereof; (c) recommendation information for the at least one device, the one or more neighboring devices, or a combination thereof; or (d) a combination thereof.

The context information of the participating devices may be extracted from the acknowledge messages, or from reply messages in response to context information query messages sent from the broadcasting device to the neighboring devices. In other embodiments, the context information of the participating devices is retrieved from the profiles database 117, the services platform 107, or a combination thereof.

By way of example, the ringtone playback scheme is “Ring Together with the Same Tone.” In this case, all participating devices execute a single ringtone as the uniform notification. As another example, the devices download (if not yet) and play the recommended ringtone in turn. As another example, each participating device plays a fixed-length sub-part of the ringtone, while only one device is ringing at a time. As another example, the devices ring sequentially with some overlaps. In these embodiments, the playback scheme module 205 may enlarge the ringing volume on each participating device, since at a time only one participating device is playing part of the ringtone as the sound needs to be heard by “distant” participating devices.

Under this scheme, multiple devices ring together may over-amplify the ringing volume. The playback scheme module 205 can analyze acknowledgement messages received from the neighboring devices to calculate the total number of neighboring devices that are going to ring together with itself. Depending on the size of the real-time neighborhood, the broadcasting device could send instructions to the participating devices to adjust their ringing volumes via updated ringtone coordination messages. By way of example, the playback scheme module 205 lowers the ringing volumes on the participating devices, if many devices are to ring at the same time. In one embodiment, the playback scheme module 205 prolongs the delay time period, such that the participating devices have enough time to process the updated ringtone coordination messages and adjust the ringing volumes.

In one embodiment, the playback scheme module 205 prolongs a ringing time length on the participating devices, in order for the broadcasting devices or other participating devices to have enough time to get aware and react to the ringtones.

By way of example, the ringtone playback scheme is “Ring Together with Different Tones.” In this case, all the participating devices communicate and agree to emit the event alert together with their own pre-selected ringtones for the notification. Most (if not all) nearby people involved in the same event hear and recognize their own notification ringtones from their mobile devices at the same time, especially when the background is noisy.

In another embodiment, the ringtone playback scheme is “Ring with Different Tones at Different Times.” By way of example, a first user device plays its specific ringtone R₁ for T₁ seconds, immediately followed by a second device plays its specific ringtone R₂ for T₂ seconds, then a third device . . . . As other examples, a first number N₁ of devices play the same or different ringtones for T₁ seconds, then N₂ devices play the same or different ringtones for T₂ seconds . . . . As another example, a first group of user devices play a specific ringtone R₁ for T₁ seconds, immediately followed by a second group of user devices play another specific ringtone R₂ for T₂ seconds, then a third group of user devices . . . . As other examples, a first number N₁ of devices located at one area play the same or different ringtones for T₁ seconds, then N₂ devices located in another area play the same or different ringtones for T₂ seconds . . . . The areas may be tables/corners in a room, rooms, floors, buildings, streets, communities, cities, countries, etc.

In another embodiment, the ringtone playback scheme is “Ring with Different Playback Modes and/or Alert Types” The playback mode may be normal, mute, vibrations, etc. The alert types may be audio, light, visual notification, multiple media, etc. The ringtone playback scheme is designed based on the context of the participating users. By way of example, if one user is next to a library, the ringtone playback scheme may be set as vibration or mute with visual pop-up.

In another embodiment, the ringtone playback scheme is “Ring Once” for multiple devices owned by a single user. When a neighboring device realizes that the broadcasting device is owned by the same user, it may suppress redundant ring notifications based upon a priority (e.g., ringing on a smart phone, while suppressing ringing on a PC), or particular context. By way of example, the playback scheme module 205 considers the context information to suppress one user device placed near a baby.

In another embodiment, the ringtone playback scheme is “Ring Periodically” for multiple devices owned by a single user or different users. By way of example, during with a P2P gaming application (e.g., a hunger game), all the participating devices of the same team decide to ring a special tone every hour to report the status of the participating device, such as a dog barking sound signaling that the user is safe, while a bear roaring sound signaling that the user is injured.

These ringtone playback schemes make sound-based notification more friendly, harmonized, and/or effective for all users. These ringtone playback schemes may reduce annoyance and interrupt during life (e.g., work) caused by sudden, transient, repetitive sound alerts. Some of these ringtone playback schemes attract/emphasize mutual attention of the multiple users who are involved in the notified event. Some of these ringtone playback schemes make the users easier to group and act for the event. Some of these ringtone playback schemes enhance potential social interactions among the users.

The recommendation module 207 recommends the ringtone based on the preferences of the users associated with the UE 101, which are determined once the contextual information is processed by the processing module 201. As the context module 203 determines contextual information, the processing module 201 processes the contextual information. Next, the recommendation module 207 recommends, according to the rankings of the neighboring devices based on their physical or social proximity, or both, the selection of ringtone based on determined popularity information. The recommendation module 207 determines whether a preferred ringtone playback for the requesting UE 101 is available or not. If a preferred ringtone is not available, the recommendation module 207 recommends a ringtone preference to the coordination platform 103. In one embodiment, the coordination platform 103 then requests the ringtone from, for example, one or more content providers 113.

The communication module 209 transmits ringtone coordination messages, query messages, updated ringtone coordination messages, and acknowledge messages as directed by the processing module 201 or the playback scheme module 205 either in a P2P mode or a client-server mode.

The messages may be sent using short range communications, such as Bluetooth, WiFi Direct, etc. In a single-hop broadcasting mode/topology, the communication module 209 transmits ringtone coordination messages, query messages, updated ringtone coordination messages from a broadcasting device to a neighboring device without relaying the messages to one or more other neighboring devices. In the single-hop mode, the communication module 209 transmits acknowledge messages from the neighboring device to the broadcasting device without relaying the acknowledge messages to one or more other neighboring devices.

In a multi-hop broadcasting mode/topology, the communication module 209 relays the above-referenced messages to one or more other neighboring devices before reaching a further distant neighboring device. Multi-hop, or ad hoc, wireless networks use two or more wireless hops to convey information from a source to a destination. The processing module 201 considers additional delay caused by the message relay to determine the delay time period, prior to sending out the ringtone coordination message to the neighboring devices.

The playback scheme module 205 considers the distance coverage of the ringtone playback scheme to inform participating devices as to whether to continue forwarding/relaying ringtone coordination message addressed to another participating device. In other embodiments, the playback scheme module 205 considers the parameters and attributes (e.g., “ring with the same tone”, “dynamic volume tuning”, etc.) of a particular ringtone playback scheme to inform participating devices as to whether to continue forwarding/relaying ringtone coordination message addressed to another participating device.

In one embodiment, the playback scheme module 205 selects a multi-hop “ring together” playback scheme based on various user contexts. By way of example, all nearby devices which share the same event alert and whose indoor/outdoor locations are within a system-defined range R from the broadcasting device will participate in the ringtone playback scheme. The broadcasting device could send ringtone coordination messages embedded with its device ID, an event alert ID, its GPS/indoor coordinates, and “ring together” parameters/attributes.

In one embodiment, the playback scheme module 205 generates different ringtone coordination messages for neighboring devices at different locations, such as near the baseball base field, outer field, etc. By way of example, the ringtone coordination message to the base field instructs the participating devices to cheer the pitcher with a woo ringtone, while the ringtone coordination message to the base field instructs the participating devices to boo the catcher with a boo ringtone. In another embodiment, the playback scheme module 205 generates different ringtone coordination messages for neighboring devices within different location ranges from the broadcasting device. By way of example, the ringtone coordination message to the 5-foot radius instructs the participating devices to ring a knocking ringtone at 10 DB, while the ringtone coordination message to the 10-foot radius instructs the participating devices to ring a raining ringtone at 25 DB, so the broadcasting device can hear both of the knocking ringtone and the raining ringtone of almost equal volumes. Since each group of participating devices receives a ringtone coordination message containing their own ringtone playback parameters/attributes, the ringtone coordination message is relative short and reaches the targeted group of participating devices faster.

In another embodiment, the playback scheme module 205 generates the same ringtone coordination message for all neighboring devices at different locations. In this case, the ringtone coordination message includes ringtone playback parameters/attributes of all participating devices so the message is relative long and takes time to reach all the participating devices.

When receiving a multi-hop ringtone coordination message, the processing module 201 computes the distances between itself and the broadcasting device, and decides whether and how to participate the ringtone playback scheme. By way of example, the neighboring device “rings together” only if it is within a range R. The devices that decide not to participate the ringtone playback scheme because of outside the range R will stop forwarding the multi-hop ringtone coordination message, so the multi-hop P2P routing will terminate at last.

As another example, user profile elements, such as organization (e.g., a team, department, company, etc.), interests, social relationships, etc. could be utilized in place of the distance from the broadcasting device. Only neighboring devices, that satisfy certain conditions in the user profile as specified in the ringtone coordination message, will join the ringtone playback scheme. These conditions are provided by the broadcasting device. In other words, the broadcasting device could send out preferences to select ad-hoc group members of a ringtone playback scheme based on the real-time contexts of nearby devices.

In another multi-hop embodiment, a device that is going to ring now might has been notified with but not actually participated in a previous ringtone playback scheme (e.g., “ring together”) due to various reasons, e.g., too far away from the broadcasting device, its user profile is not matched by rules, etc. This device has snooped a few parameters of the previous “ring together” actions, such as ringtone IDs, participating devices, etc. This device can use these parameters as additional contexts to better schedule/coordinate its current “ring together” action, e.g., play the same ringtone, play a different ringtone, etc.

This device can even consider the contexts of “obsolete” participating devices that have been involved in the previous “ring together” action to ring again. For these “obsolete” participating devices, the sound plays for a while and the on-screen notification disappears automatically after a few seconds, since the user has been notified before for the same event. The purpose is to attract the user's attention—you have missed some potential “ring together” accompanies previously!

T_{d} (delay) is selected by the broadcasting device. Based on this T_{d} value, the length of the multi-hop (i.e., a total number of hops) could be estimated. By way of example, for Wi-Fi Direct or Bluetooth LE, the broadcasting device estimates a broadcasting range by transmission rates. In another embodiment, the broadcasting device amortizes the time delay from T_{d}. In yet another embodiment, for inaudible sounds, the broadcasting device estimates the transmission rate and the sound damping rate in the air. In yet another embodiment, the broadcasting device determines different delay time periods for different groups of participating devices to meet the application at each group.

The rendering module 211 renders the ringtone playback scheme based upon the parameters/attributes described in the ringtone coordination message and the update ringtone coordination messages.

The monitor module 213 monitors the profiles database 117, the ringtone database 119 and the location database 121. The monitor module 213 keeps the databases updated. Each time a UE 101 sends a ringtone coordination message, a query message, an updated ringtone coordination message, the monitor module 213 compares the contextual information and updates the contextual information in the profiles database 117, the ringtone database 119 and the location database 121. The monitor module 213 monitors for updates continuously, periodically, according to a schedule, on demand, or a combination thereof. The monitoring can be based on any monitoring schedule.

The monitor module 213 may cause, at least in part, an updating of one or more lists of neighboring devices and/or participating devices, the at least one ringtone, or a combination thereof based, at least in part, on the monitoring. When the contextual information changes as determined based on the monitoring, the monitor module 213 can update any or all of the lists and provided ringtones based on the changes. In one embodiment, the changes in the contextual information that result in an update of the lists and/or ringtone may occur if the changes satisfy one or more thresholds. For example, changes in the locations of the devices may trigger updates to the ringtone if the changes in the location satisfy a location change threshold.

The monitor module 213 forwards the updates to the playback scheme module 205 to determine whether to adjust the ringtone playback scheme. The monitor module 213 forwards the updates to the recommendation module 207 to determine whether to adjust the recommendations. Thus, the monitor module 213 may not cause changes to, for example, the ringtone after every small change in the context information.

In one embodiment, the broadcasting device invites the users of the participating devices to select different, independent volume control capabilities for ringtones and digital audio playback. In one embodiment, the update information may include the ringtone playback capability changes and/or ringtone volume changes of the participating devices based on the update perceived volume of digital ringtone playback (e.g., very loud, loud, medium, soft, very soft, and off) selected by the users of the participating devices. The context module 203 processes the update information to adjust the volume levels of the participating devices in consideration of the environment (e.g., ambient noise information) to, at least in part, ascertain the ringtone playback volumes set by each participating device can be received by the broadcasting device at the selected volume. By way of example, the adjusted ringtone playback volume is bigger when the ambient noise information indicates that the ambient noise is high based on the damping qualities in relation to distance and ambient noise levels.

The applications 111 executed at the UE 101 may perform all or some of the functions of the coordination platform 103 such that the functions (e.g., generating a ringtone playback scheme) of the coordination platform 103 are embodied in the applications 111. In some embodiments, the applications 111 enables the UE 101 to interact with, for instance, the coordination platform 103 to perform all or some of the functions of the coordination platform 103.

In one embodiment, the applications 111 of the UEs 101 interact with one another according to a peer-to-peer (P2P) model to render ringtones with a delay time period based upon location information associated with the broadcasting device. By way of example, a coordination application 111a of a broadcasting device sets or calculates a delay time period for a ringtone playback scheme, and sends out a ringtone coordination message to neighboring devices to set up the delayed-ringtone for a group of participating devices that share the same event alert. The coordination applications 111a of the UEs 101 acknowledge their participation in the same event alerts to each other via acknowledge messages. Based upon the context information updates of the participating devices, the coordination application 111a of the broadcasting device provides more intelligence fitting to the ringtone playback scheme, for example, to shut-off the rest of devices of the same user, or to lower the volumes of some devices. When receiving multiple ringtone coordination messages from more than one device, a neighboring device determines to respond to only one broadcasting device based upon a predetermined policy (e.g., based on context information). This P2P model does not require any server.

In another embodiment, the applications 111 of the UEs 101 and the coordination platform 103 interact according to a client-server model to at least provide a ringtone playback scheme, friend/event/advertisement recommendations, etc. In another embodiment, at any time, either the broadcasting device or the coordination platform 103 can take over from the other the real-time coordination by sending further instructions to the neighboring devices.

In addition, the applications 111 render the ringtones based on their own rendering capabilities. By way of example, when the UEs 101 include a three-dimensional display screen, the applications 111 can also render the visual notifications as an object with the 3D respective, etc.

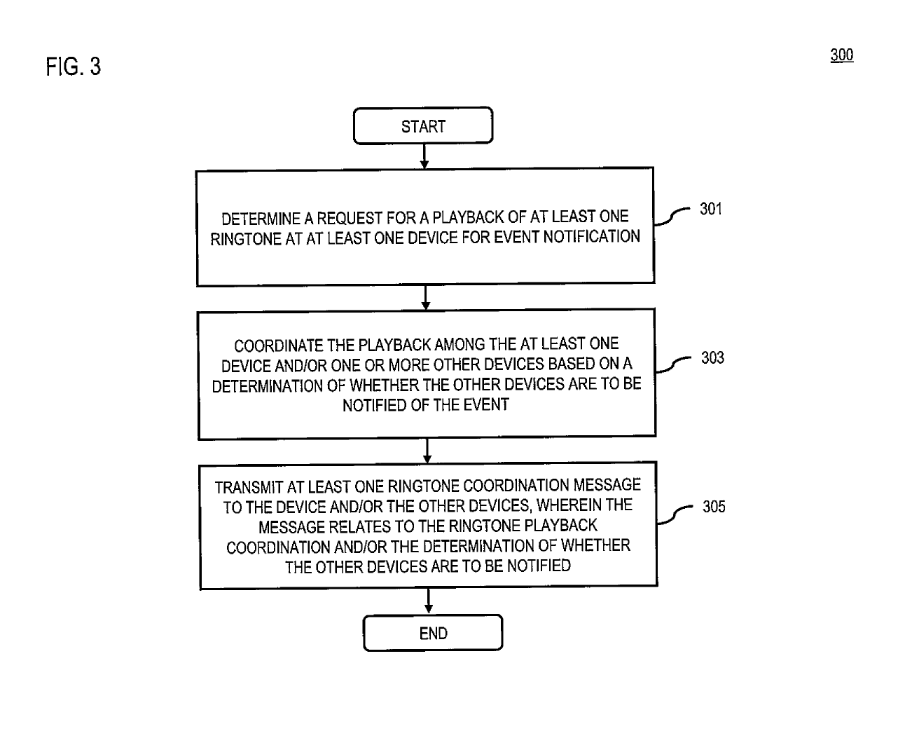

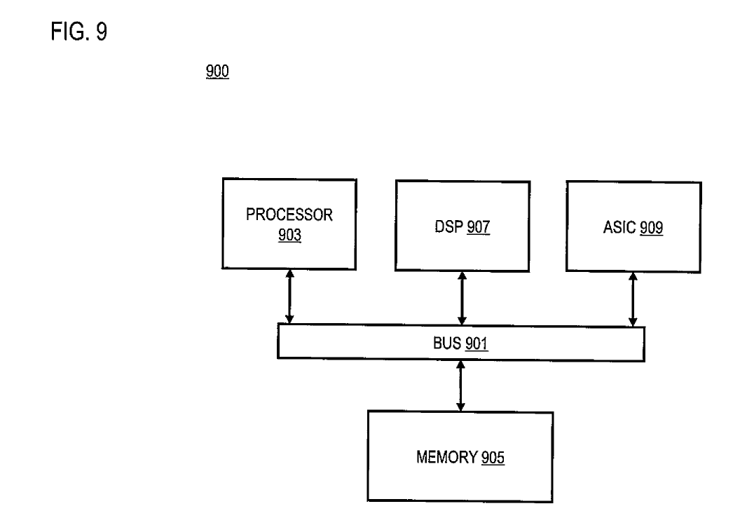

FIG. 3 is a flowchart of a process for determining a ringtone playback scheme for devices, according to one embodiment. In one embodiment, a coordination application 111a of a broadcasting device performs the process 300 and is implemented in, for instance, a chip set including a processor and a memory as shown in FIG. 9.

In step 301, the coordination application 111a determines a request for a playback of at least one ringtone at at least one device, wherein the playback is for a notification of at least one event. By way of example, the request may be sent prior to the UE 101 playing a ringtone, such as upon receiving an incoming call, SMS message, MMS message, email and prior to playing a sound in response.

In step 303, the coordination application 111a causes, at least in part, a coordination of the playback of the at least one ringtone among the at least one device, one or more other devices, or a combination thereof based, at least in part, on a determination of whether the one or more other devices are to be notified of the at least one event. In one embodiment, the coordination application 111a determines the one or more other devices based, at least in part, on a proximity of the one or more other devices to the at least one device, contextual information associated with the one or more other devices, or a combination thereof.

The contextual information may include, for example, user profile information, user preference information, location information, temporal information, activity information, or a combination. The contextual information may be determined from one or more applications 111 executed by the UE 101 and/or the neighboring devices, one or more sensors 115 associated with the UE 101 and/or the neighboring devices, one or more services 109 on the services platform 107, and/or content providers 113.

In one embodiment, the coordination application 111a may process the contextual information to determine one or more lists of one or more candidate ringtones for the at least one device, the one or more participating devices, or a combination thereof. Based on the determination of the participating devices, the coordination application 111a can determine one or more lists of preferred ringtones associated with the one or more devices that are stored in, for example, the profiles database 117. The lists may be created based on the coordination application 111a acquiring information regarding user preferences that are related to the ringtones, such that a device associated with a user is associated with a preferred list of ringtones. Each list may correspond to, therefore, candidate ringtones that may be further processed to select a ringtone.

In one embodiment, after determining the rankings and the candidate lists of ringtones, the coordination application 111a processes the contextual information and selects a ringtone from the lists. Where the selection is based solely on the lists, the coordination application 111a may determine the ringtone based on any type of analysis with respect to the lists. By way of example, the coordination application 111a may select the ringtone with the highest average position among the lists, the ringtone with the most occurrences as the first ringtone, and so forth. The determination may further be adjusted based on the ranking and weighting. For example, the lists associated with devices and/or users that include a higher ranking may be considered more than the lists associated with the devices and/or users that include lower rankings. Thus, even though one ringtone may be listed as the most preferred ringtone on many lists, these lists may not be ranked as highly as other lists that include a different ringtone as the most preferred ringtone. Accordingly, based on the lists and the rankings, the coordination application 111a determines a ringtone to provide the broadcasting device for playback.

In one embodiment, the coordination application 111a determines contextual information associated with the one or more other devices by causing, at least in part, transmission of a query message for the contextual information from the at least one device to the one or more neighboring devices. The query message can be sent before, in conjunction with, embedded in, or after the ringtone coordination message. The contextual information may indicate one or more of profile, preference, temporal, spatial, environmental, and activity circumstances of one or more users associated with the one or more neighboring devices. By way of example, a user profile may include interests, shopping history, home/office locations, activities, SNS relationships, etc.

In one embodiment, the coordination application 111a processes the contextual information to determine a range associated with the playback of the ringtone and the neighboring devices that are within the range and that are associated with users who will hear the playback of the ringtone. The coordination application 111a may further determine the context information associated with the neighboring devices to determine the preferences of the users of the devices to determine a ringtone that will be generally preferred by all of the users who will be in the vicinity to hear the ringtone. The coordination application 111a may also consider the preferences of the user of the broadcasting UE 101. Accordingly, the coordination application 111a may provide a ringtone playback scheme.

In one embodiment, the coordination application 111a determines the proximity based, at least in part, on a physical distance, one or more communication hops, or a combination thereof.

In step 305, the coordination application 111a causes, at least in part, a transmission of at least one ringtone coordination message to the at least one device, the one or more other devices, or a combination thereof. In one embodiment, the at least one ringtone coordination message relates, at least in part, to the coordination of the playback of the at least one ringtone, the determination of whether the one or more other devices are to be notified of the at least one event, or a combination thereof.

In one embodiment, the coordination application 111a determines at least one acknowledgement message from the one or more other devices in response to the at least one ringtone coordination message. The coordination application 111a determines the neighboring devices that acknowledge participation in the ringtone playback, based, at least in part, on the one or more acknowledgement messages. The coordination of the playback is based, at least in part, on the at least one acknowledgement message.

In one embodiment, the coordination application 111a determines a delay of the at least one ringtone playback at the at least one device based, at least in part, on a type of the at least one event, a transmission time for the at least one ringtone coordination message, user preference information, or a combination thereof. In one embodiment, the coordination application 111a causes, at least in part, the delay of the at least one ringtone playback at the at least one device, wherein the coordination of the playback, the determination of whether the one or more other devices are to be notified, or a combination thereof is performed during the delay. In one embodiment, the coordination application 111a determines the one or more other devices based, at least in part, on whether the one or more other devices are capable of receiving, processing, or a combination thereof the at least one ringtone coordination message during the delay.

In one embodiment, the ringtone coordination message includes (a) ringtone playback information of timing, content, one or more volumes, one or more lengths, one or more frequencies, one or more playback delay time periods (e.g., T_{d}), one or more alert types (e.g., audio, non-audio, pop-up, etc.), one or more playback modes (e.g., normal, vibrate, mute, etc.), or a combination thereof, of the playback; (b) location information of the at least one device, the one or more neighboring devices, or a combination thereof; (c) recommendation information for the at least one device, the one or more neighboring devices, or a combination thereof; or (d) a combination thereof.

In one embodiment, each of the one or more playback delay time periods defines a time period from receiving the ringtone coordination message to a starting time of the ringtone playback.

In one embodiment, the one or more alert types are presented in conjunction with one or more ringtones. In another embodiment, the one or more alert types are presented in place of one or more ringtones.

In one embodiment, the coordination comprises: causing, at least in part, a simultaneous or substantially simultaneous initiation of the playback of the at least one ringtone at the at least one device, the one or more other devices, or a combination thereof.

In another embodiment, the coordination comprises: causing, at least in part, a sequential playback of at least a portion of the at least one ringtone at the at least one device, the one or more other devices, or a combination thereof.

In yet another embodiment, the coordination comprises: determining a selected one of the device and the one or more other devices; causing, at least in part, an initiation of the playback at the selected one; and causing, at least in part, a suppression of the playback at remaining one or more of the device and the one or more other devices. The determination of the selected one is based, at least in part, on (a) ownership information associated with the device, the one or more devices, or a combination thereof; (b) social relationship information among the device, the one or more devices, or a combination thereof; or (c) a combination thereof.

In yet another embodiment, the coordination comprises: determining a priority of the at least one device, the one or more other devices, or a combination thereof; and determining a timing of the playback among the at least one device, the one or more other devices, or a combination thereof based, at least in part, on the priority. By way of example, the playback starts with alerting meeting organizers, required participants, and then optional participants. As another example, an airport priority boarding ringtone playback scheme starts with passengers with special needs, first class passengers, business class passengers, and then economy class passengers.

In one embodiment, the coordination application 111a determines to adjust the timing, content, one or more volumes, one or more lengths, one or more frequencies, one or more playback delay time periods, one or more media types, one or more playback modes, or a combination thereof, of the ringtone playback, based, at least in part, on contextual information of the participating neighboring devices. Thereafter, the coordination application 111a causes, at least in part, transmission of an updated ringtone coordination message with the adjusted information of the ringtone playback to the participating neighboring devices.

In one embodiment, the coordination application 111a causes, at least in part, rendering the ringtone playback based, at least in part, on the ringtone playback information (e.g., timing, content, volumes, lengths, frequencies, playback delay time periods, alert types, playback modes, or a combination thereof, of the playback).

In another embodiment, the coordination application 111a causes, at least in part, representation of the ringtone playback information at the at least one device, the one or more neighboring devices, or a combination thereof. The representation can be textual, graphics (e.g., pie chart, table, etc.), etc. of one or more elements of the ringtone playback information (e.g., timing, content, volumes, lengths, frequencies, playback delay time periods, alert types, playback modes, or a combination thereof, of the playback).

In another embodiment, the coordination application 111a causes, at least in part, a map representation indicating the at least one device, the one or more neighboring devices, or a combination thereof, based, at least in part, on the location information.

In yet another embodiment, the coordination application 111a causes, at least in part, representation of the recommendation information at the at least one device, the one or more neighboring devices, or a combination thereof, wherein the recommendation information includes one or more advertisements, one or more social contacts, or a combination thereof, recommended for the at least one device, the one or more neighboring devices, or a combination thereof.

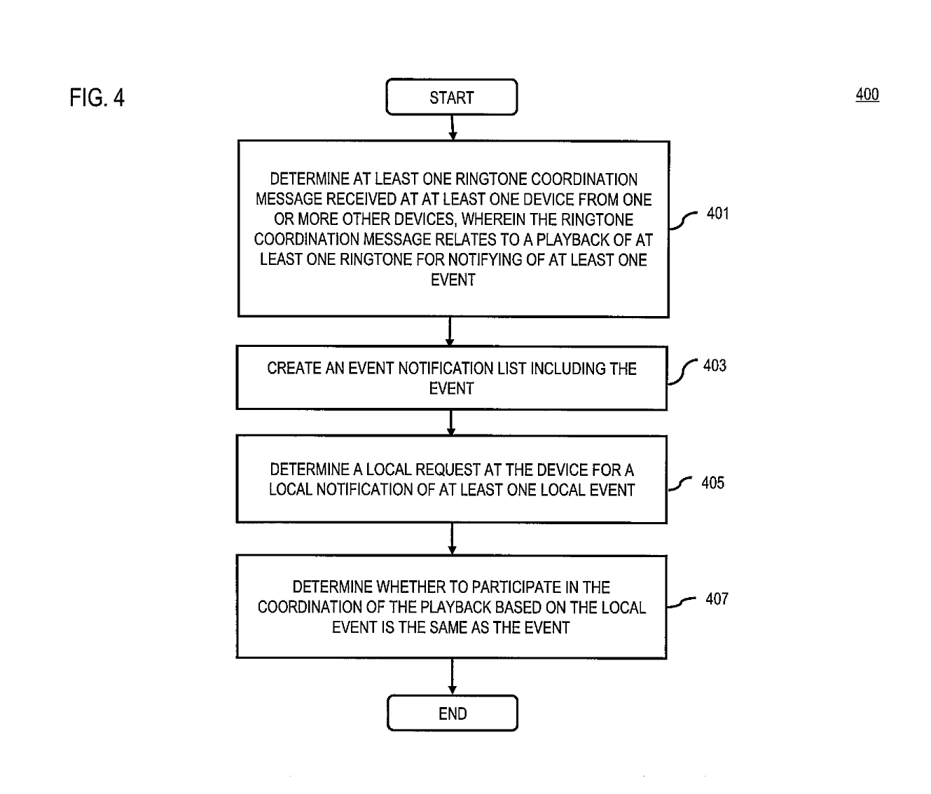

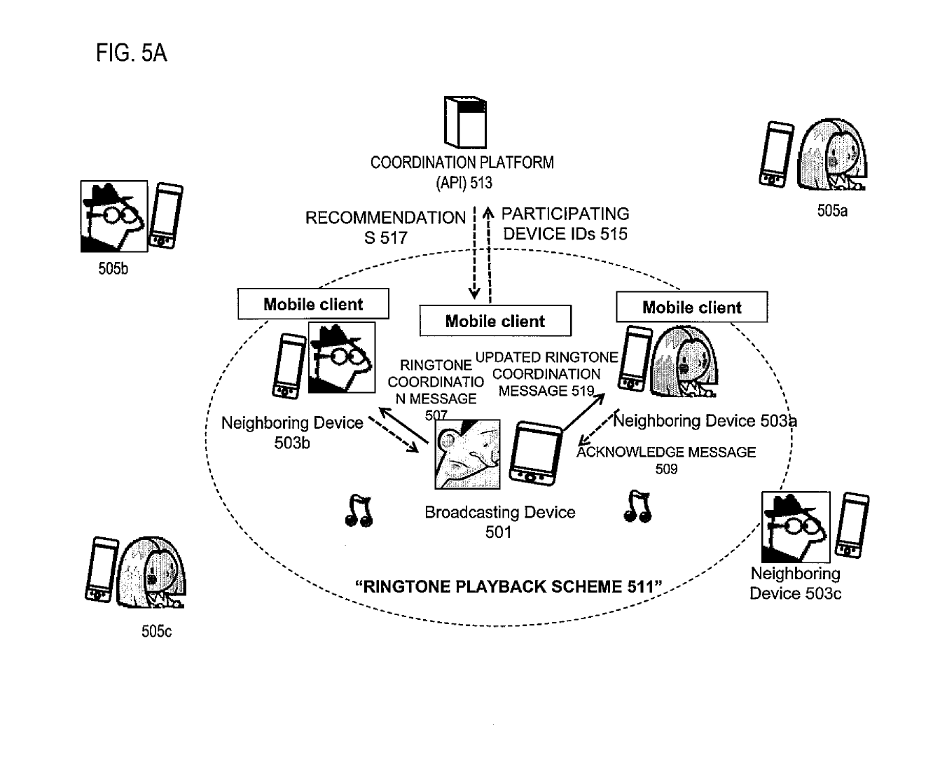

FIG. 4 is a flowchart of a process for responding to a ringtone coordination message by a neighboring device, according to one embodiment. In one embodiment, a coordination application 111a of a neighboring device performs the process 400 and is implemented in, for instance, a chip set including a processor and a memory as shown in FIG. 9.

In step 401, the coordination application 111a determines at least one ringtone coordination message received at at least one device from one or more other devices, wherein the at least one ringtone coordination message relates to a playback of at least one ringtone for notifying of at least one event.

In step 403, the coordination application 111a causes, at least in part, a creation of an event notification list including, at least in part, the at least one event.

In step 405, the coordination application 111a determines a local request at the least one device for a local notification of the at least one local event.

In step 407, the coordination application 111a determines whether to participate in the coordination of the playback based, at least in part, on the at least one local event is the same as the at least one event in the event notification list.

When determining to participate in the ringtone playback, the coordination application 111a causes at least in part, a coordination of the playback of the at least one ringtone among the at least one device, the one or more other devices, or a combination thereof based, at least in part, on whether the at least one device is to be notified of the at least one event.

When determining not to participate in the ringtone playback, the coordination application 111a causes, at least in part, a generation of at least one other ringtone coordination message regarding the at least one local event if the at least one local event is not the same as the at least one event in the event notification list. Thereafter, the coordination application 111a causes, at least in part, a transmission of the at least one other ringtone coordination message to one or more neighboring devices.

In one embodiment, the coordination application 111a determines a delay for the playback from the at least one ringtone coordination message. The coordination application 111a then causes, at least in part, an initiation of the playback at the at least one device based, at least in part, on the delay if the at least one device is to be notified of the at least one event.

In one embodiment, the coordination includes, at least in part, (a) a simultaneous or substantially simultaneous playback of the at least one ringtone that is different or the same for the at least one device, the one or more other devices, or a combination thereof; (b) a sequential playback of at least a portion of the at least one ringtone that is different or the same for the at least one device, the one or more other devices, or a combination thereof; (c) a selection of at least one of the at least one device, the one or more other devices, or a combination for the playback with suppression of remaining one or more of the at least one device, the one or more other devices, or a combination thereof; (d) the playback of the at least one ringtone based, at least on a priority of the at least one device, the one or more devices, or a combination thereof; (e) the playback of the at least one ringtone based, at least in part, on contextual information associated with the at least one device, the one or more other devices, or a combination thereof; or (f) a combination thereof.

In one embodiment, the ringtone coordination message includes (a) ringtone playback information of timing, content, one or more volumes, one or more lengths, one or more frequencies, one or more playback delay time periods (e.g., T_{d}), one or more alert types (e.g., audio, non-audio, pop-up, etc.), one or more playback modes (e.g., normal, vibrate, mute, etc.), or a combination thereof, of the playback; (b) location information of the at least one device, the one or more neighboring devices, or a combination thereof; (c) recommendation information for the at least one device, the one or more neighboring devices, or a combination thereof; or (d) a combination thereof.

In another embodiment, the coordination application 111a receives two or more ringtone coordination messages originated from two or more neighboring devices. The coordination application 111a determines contextual information associated with the device and the two or more neighboring devices. The coordination application 111a determines a priority of the two or more ringtone coordination messages, based, at least in part, on the contextual information. The coordination application 111a then causes, at least in part, rendering the ringtone playback by the device for the two or more ringtone coordination messages based, at least in part, on the priority.

By way of example, the coordination application 111a processes the contextual information to cause, at least in part, a ranking of the one or more participating devices based, at least in part, a physical proximity, a social proximity, or a combination thereof to the at least one device. The physical proximity may determinate based on the nearness in location the participating devices are to the user device that requests the ringtone from the coordination platform 103. The social proximity is determined based on the proximity of participating devices associated with user profile information, user preference information, location information, temporal information, activity information, or a combination. By way of example, one type of social proximity may be the social relationship between the owners of two devices as established on a social networking service 109a. For instance, two owners of devices may simply be designated as acquaintances on the social networking service 109, one of the owners and another owner may be designated as friends on the social networking service 109, while one of the owners and another owner may be designated as family. The various designations may represent rankings of the owners, such that the family is ranked highest and the mere acquaintance is ranked the lowest among the group of owners in terms of the social proximity.

In another embodiment, the coordination application 111a further determines one or more weighting values for the one or more participating devices based, at least in part, on the ranking. The coordination application 111a may weigh the variously ranked participating devices different such that, for example, higher ranked devices and given a larger weighting in terms of determining a ringtone than lower ranked devices. By way of example, in terms of physical proximity, devices that are ranked higher because they are closer to the broadcasting device may be given a higher weighting. This higher weighting may reflect the better chance the users of the closer devices have to hearing the ringtone. Because the users of the closer devices have a better chance in hearing the ringtone, the coordination application 111a weights their preferences in ringtones more so that they hear a ringtone that they prefer, rather than a ringtone that someone farther away prefers yet is less likely to hear. By way of another example, in terms of social proximity, devices that are ranked higher in social proximity may be given higher weightings because the user of the broadcasting device may give higher significance to, for example, the opinions of the users of the higher socially ranked devices. The coordination application 111a may place more significance in what close family members prefer to hear rather than merely close acquaintances.

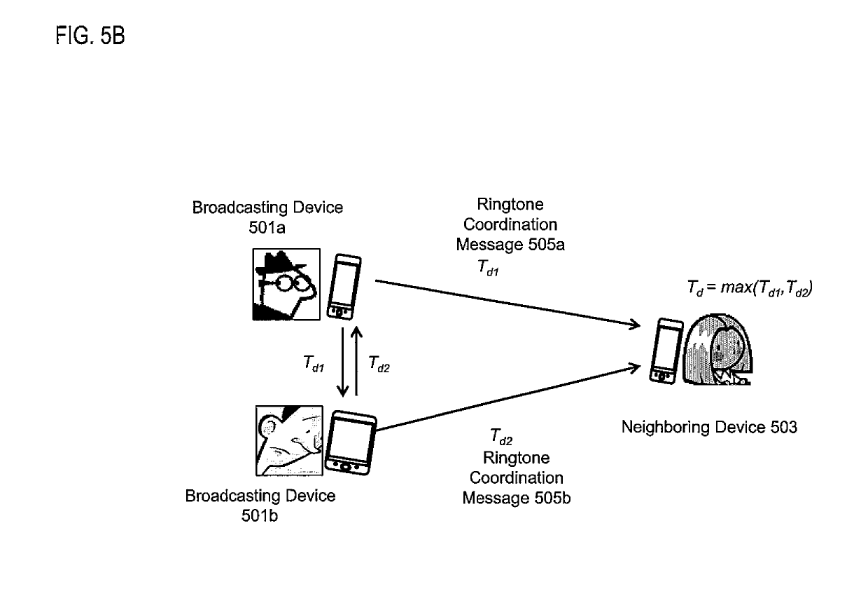

FIG. 5A is a system diagram utilizing the processes of FIGS. 3-4, according to one embodiment. Illustrated are a broadcasting device 501 communicating with neighboring devices to determine which devices are participating devices in the neighborhood. Due to the limitation of a broadcast range of the broadcasting device 501, only neighboring devices 503 receive messages from the broadcasting device 501, while neighboring devices 505a, 505b, 505c do not receive messages from the broadcasting device 501.

In response to the ringtone coordination message 507 from the broadcasting device 501, only neighboring devices 503a, 503b determine that they have the same event alert and then send out acknowledge messages 509 back to the broadcasting device 501. The neighboring device 503c does not have the same event alert and does not reply to the broadcasting device 501.

Based upon the acknowledge messages 509 and context information of the participating devices, the broadcasting device 501 determines a ringtone playback scheme 511. The context information of the neighboring devices 503a, 503b may be included in the acknowledge messages 509, or retrieved from a coordination platform 513. By sending the participating device ID 515 extracted from the acknowledge messages 509 to the coordination platform 513, the broadcasting device 501 can also obtain recommendations 517 of ringtones, events, friends, advertisements, etc. from the coordination platform 513.

The broadcasting device 501 sends out the parameters/attributes of the ringtone playback scheme 511 via updated ringtone coordination messages 519 to the participating devices 503a, 503b. Optionally, the updated ringtone coordination messages 519 include the recommendations of events, friends, advertisements, etc.

FIG. 5B is a diagram depicting a conflict resolution process, according to one embodiment. Illustrated are broadcasting devices 501a, 501b which send to a neighboring device 503 ringtone coordination messages 505a, 505b for the same event alert simultaneously or substantially simultaneously. The neighboring device 503 selects and uses the largest value T_{d} of the delay time periods T_{d1}, T_{d2} specified in the messages 505a, 505b.

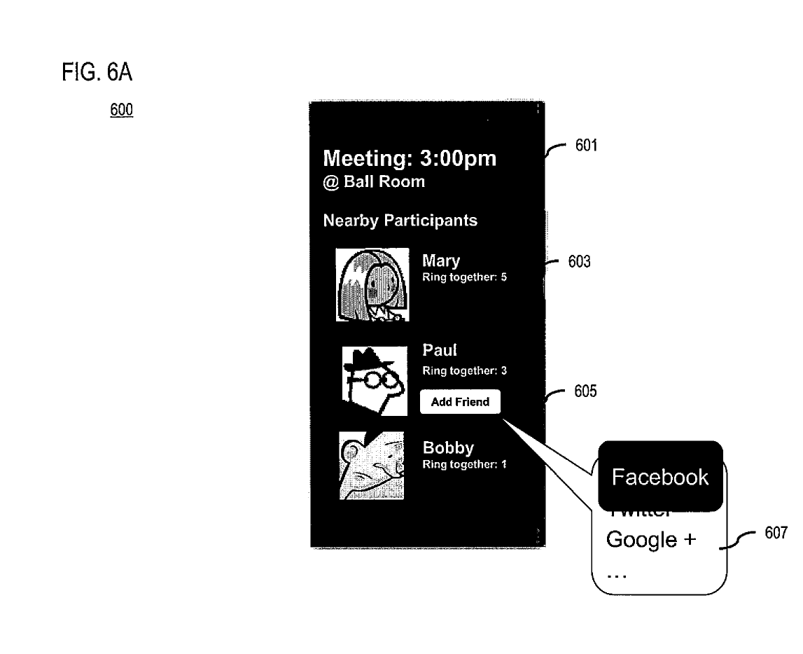

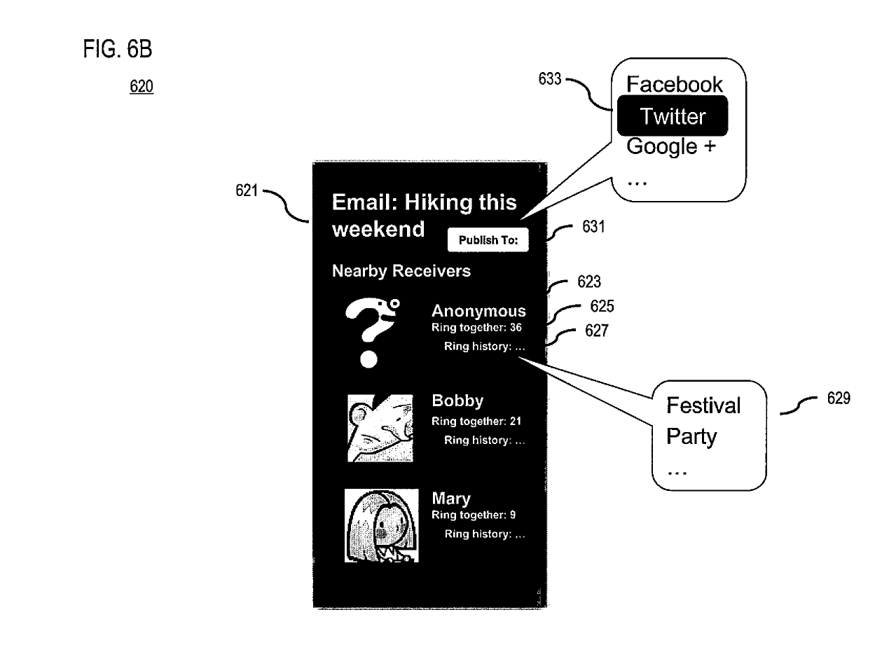

FIGS. 6A-6B are list views shown in user interfaces utilized in the processes of FIGS. 3-4, according to various embodiments. Illustrated in FIG. 6A is a user interface 600 of a list view on a broadcasting device. The user interface 600 is opened within a meeting scheduling application that shows in a field 601 a meeting scheduled at 3 pm to be held in the ball room. The user interface 600 lists three nearby participating devices of Mary, Paul, and Bobby. The list may be displayed in order of geographic distance, priority, etc.

Below each user name (e.g., Mary) is a data field 603 showing a number of recent meeting alert ring together (e.g., 5 times) with the user (e.g., John) of the broadcasting device by the other user (e.g., Mary) of a participation device. The number of recent meeting alert ring together (e.g., 5 times) may imply a number of recent meetings attended together.

Below each data field 603 is another data tab or icon 605 prompting the broadcasting device user John to add the participating device user Paul as a friend. When John selects the tab 605, a pop-up 607 may list all social network options that John subscribes to. In another embodiment, a pop-up 607 lists the social network options that both John and Paul subscribe to (but not yet connected thereat). John can then choose any of the options to be a friend with Paul.

Illustrated in FIG. 6B is a user interface 620 of a list view on a broadcasting device. The user interface 620 is opened within an email application that shows in a field 621 of an email for a hiking event scheduled for the coming weekend. The user interface 620 lists three nearby email recipient devices of Anonymous, Bobby, and Mary. A user name field 623 can be shown as “Anonymous” to hide the user profile (e.g., name, photo, etc.) for privacy.

Below each user name (e.g., Anonymous) is a data field 625 showing a number of recent email alert ring together (e.g., 36 times) with the user (e.g., John) of the broadcasting device by the other user (e.g., Anonymous) of a participation device. The number of recent email alert ring together (e.g., 35 times) may imply a number of recent emails received together.

Below each data field 625 is another data tab or icon 627 prompting the broadcasting device user John to view the ring history with the participating device of the anonymous user. When John selects the tab 627, a pop-up 629 may list all emails (regarding a festival, party, etc.) that John and the anonymous user ringed together. John can then choose any of the mails to view the content.

Below the field 621 is a data tab or icon 631 prompting the broadcasting device user John to publish the hiking event email via one or more social networks. When John selects the tab 631, a pop-up 633 may list all social network options that John subscribes to. John can then choose any of the options to publish the hiking event email.

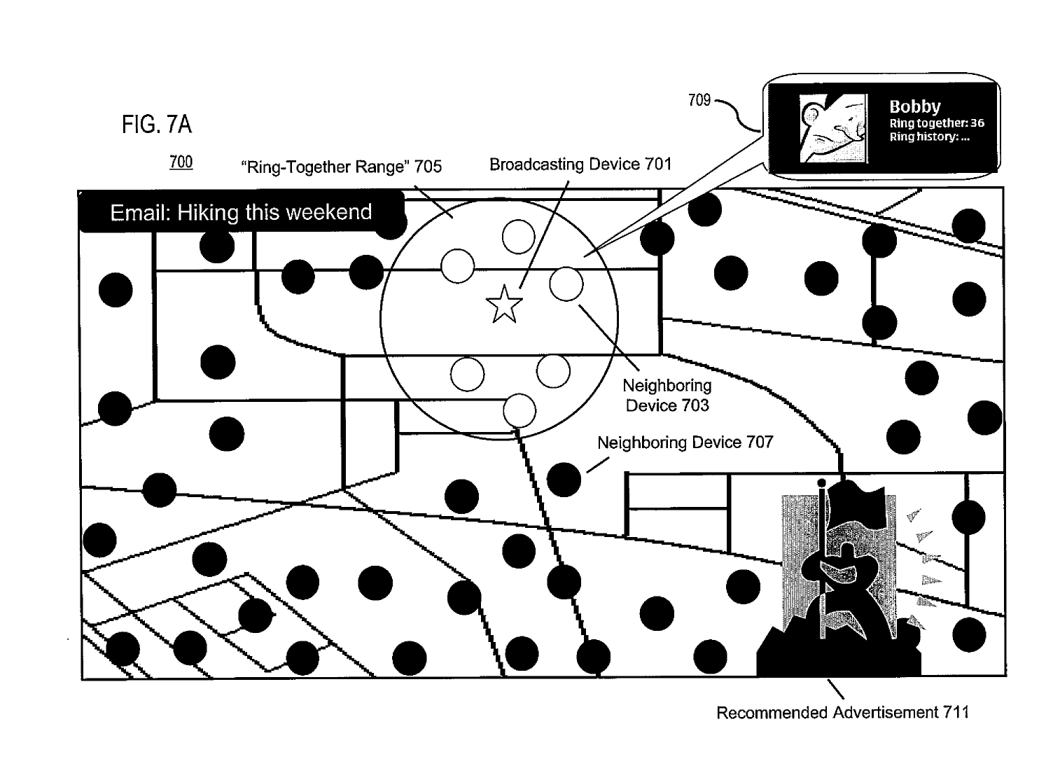

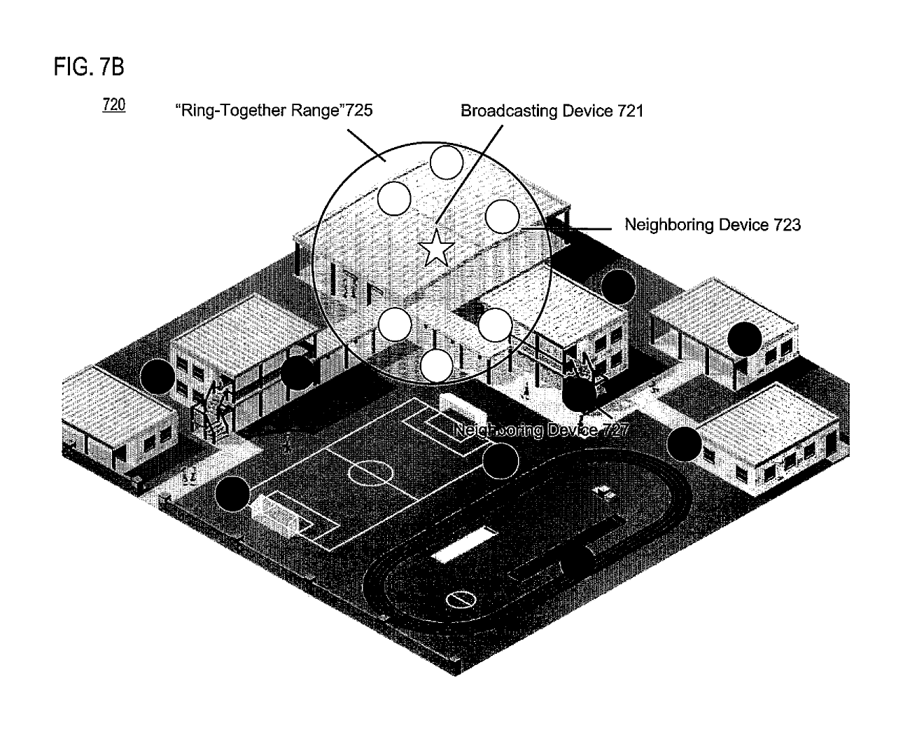

FIGS. 7A-7B are map views shown in user interfaces utilized in the processes of FIGS. 3-4, according to various embodiments. Illustrated in FIG. 7A is a user interface 700 of a 2D map view on a broadcasting device. The user interface 700 is opened within the same email application as FIG. 6B with respect to the email of the hiking event scheduled for the coming weekend. The user interface 700 shows a floor plan of an office building with a broadcasting device 701 marked with a start tag, neighboring devices 703 (e.g., participating devices) within a ring-together range 705 marked with a white dot, and neighboring devices 707 (e.g., non-participating devices) outside of the ring-together range 705 marked with a black dot.

A user of the broadcasting device 701 can click any of the dots to view user profile and/or “ring together” metadata in a pop-up 709. The user interface 700 also shows an recommended advertisement 711 related to hiking.

Illustrated in FIG. 7B is a user interface 720 of a 3D map view on a broadcasting device. The user interface 720 is opened within the same email application as FIG. 7A with respect to the email of the hiking event scheduled for the coming weekend. The user interface 720 shows a floor plan of an office building with a broadcasting device 721 marked with a start tag, neighboring devices 723 (e.g., participating devices) within a ring-together range 725 marked with a white dot, and neighboring devices 727 (e.g., non-participating devices) outside of the ring-together range 725 marked with a black dot.

The processes described herein for providing device ringtone coordination may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

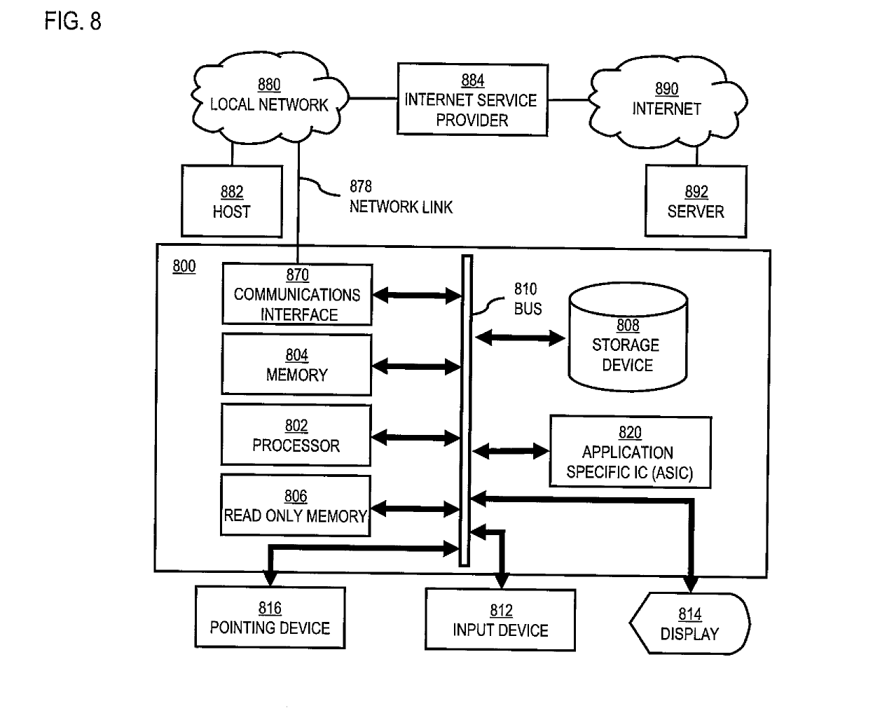

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to provide device ringtone coordination as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of providing device ringtone coordination.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to provide device ringtone coordination. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for providing device ringtone coordination. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing device ringtone coordination, is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communications interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communications interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communications interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for providing device ringtone coordination to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to provide device ringtone coordination as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of providing device ringtone coordination.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide device ringtone coordination. The memory 905 also stores the data associated with or generated by the execution of the inventive steps.

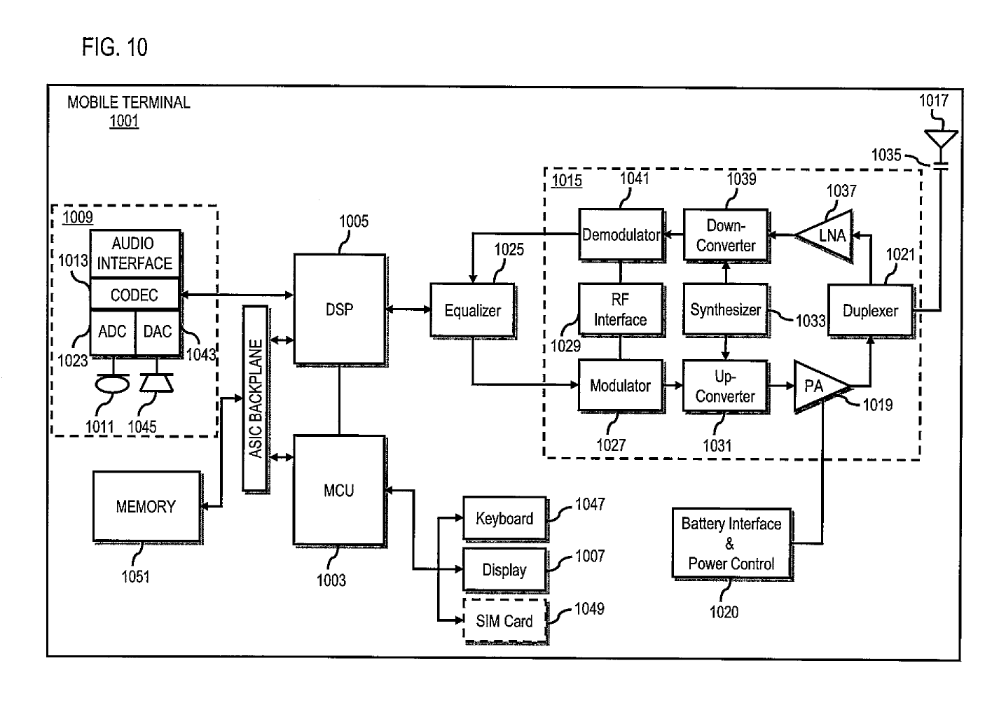

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of providing device ringtone coordination. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of providing device ringtone coordination. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission through the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to provide device ringtone coordination. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-68. (canceled)

69. A method comprising:
determining a request for a playback of at least one ringtone at least one device, wherein the playback is for a notification of at least one event; and
causing, at least in part, a coordination of the playback of the at least one ringtone among the at least one device, one or more other devices, or a combination thereof based, at least in part, on a determination of whether the one or more other devices are to be notified of the at least one event.

70. A method of claim 69, further comprising:
causing, at least in part, a transmission of at least one ringtone coordination message to the at least one device, the one or more other devices, or a combination thereof,
wherein the at least one ringtone coordination message relates, at least in part, to the coordination of the playback of the at least one ringtone, the determination of whether the one or more other devices are to be notified of the at least one event, or a combination thereof.

71. A method of claim 70, further comprising:
causing, at least in part, a delay of the at least one ringtone playback at the at least one device,
wherein the coordination of the playback, the determination of whether the one or more other devices are to be notified, or a combination thereof is performed during the delay.

72. A method of claim 71, further comprising:
determining the delay based, at least in part, on a type of the at least one event, a transmission time for the at least one ringtone coordination message, user preference information, or a combination thereof.

73. A method of claim 71, further comprising:
determining the one or more other devices based, at least in part, on whether the one or more other devices are capable of receiving, processing, or a combination thereof the at least one ringtone coordination message during the delay.

74. A method of claim 70, further comprising:
determining at least one acknowledgement message from the one or more other devices in response to the at least one ringtone coordination message,
wherein the coordination of the playback is based, at least in part, on the at least one acknowledgement message.

75. A method of claim 70, wherein the ringtone coordination message includes, at least in part, (a) ringtone playback information of timing, content, one or more volumes, one or more lengths, one or more frequencies, one or more playback delay time periods, one or more alert types, one or more playback modes, or a combination thereof, of the playback; (b) location information of the at least one device, the one or more neighboring devices, or a combination thereof; (c) recommendation information for the at least one device, the one or more neighboring devices, or a combination thereof; or (d) a combination thereof.

76. A method of claim 69, further comprising:
determining the one or more other devices based, at least in part, on a proximity of the one or more other devices to the at least one device, contextual information associated with the one or more other devices, or a combination thereof.

77. A method of claim 76, further comprising:
determining the proximity based, at least in part, on a physical distance, one or more communication hops, or a combination thereof.

78. An apparatus comprising:
at least one processor; and
at least one memory including computer program code for one or more programs,
the at least one memory and the computer program code configured to, with the at least one processor, cause the apparatus to perform at least the following,
determining a request for a playback of at least one ringtone at least one device, wherein the playback is for a notification of at least one event; and
causing, at least in part, a coordination of the playback of the at least one ringtone among the at least one device, one or more other devices, or a combination thereof based, at least in part, on a determination of whether the one or more other devices are to be notified of the at least one event.

79. An apparatus of claim 78, wherein the apparatus is further caused to:
causing, at least in part, a transmission of at least one ringtone coordination message to the at least one device, the one or more other devices, or a combination thereof,
wherein the at least one ringtone coordination message relates, at least in part, to the coordination of the playback of the at least one ringtone, the determination of whether the one or more other devices are to be notified of the at least one event, or a combination thereof.

80. An apparatus of claim 79, wherein the apparatus is further caused to:
causing, at least in part, a delay of the at least one ringtone playback at the at least one device,
wherein the coordination of the playback, the determination of whether the one or more other devices are to be notified, or a combination thereof is performed during the delay.

81. An apparatus of claim 80, wherein the apparatus is further caused to:
determining the delay based, at least in part, on a type of the at least one event, a transmission time for the at least one ringtone coordination message, user preference information, or a combination thereof.

82. An apparatus of claim 80, wherein the apparatus is further caused to:
determining the one or more other devices based, at least in part, on whether the one or more other devices are capable of receiving, processing, or a combination thereof the at least one ringtone coordination message during the delay.

83. An apparatus of claim 79, wherein the apparatus is further caused to:
determining at least one acknowledgement message from the one or more other devices in response to the at least one ringtone coordination message,
wherein the coordination of the playback is based, at least in part, on the at least one acknowledgement message.

84. An apparatus of claim 79, wherein the ringtone coordination message includes, at least in part, (a) ringtone playback information of timing, content, one or more volumes, one or more lengths, one or more frequencies, one or more playback delay time periods, one or more alert types, one or more playback modes, or a combination thereof, of the playback; (b) location information of the at least one device, the one or more neighboring devices, or a combination thereof; (c) recommendation information for the at least one device, the one or more neighboring devices, or a combination thereof; or (d) a combination thereof.

85. An apparatus of claim 78, wherein the apparatus is further caused to:
determining the one or more other devices based, at least in part, on a proximity of the one or more other devices to the at least one device, contextual information associated with the one or more other devices, or a combination thereof.

86. An apparatus of claim 85, wherein the apparatus is further caused to:
determining the proximity based, at least in part, on a physical distance, one or more communication hops, or a combination thereof.

87. A computer program product including one or more sequences of one or more instructions which, when executed by one or more processors, cause an apparatus to at least perform the steps:
determining a request for a playback of at least one ringtone at least one device, wherein the playback is for a notification of at least one event; and
causing, at least in part, a coordination of the playback of the at least one ringtone among the at least one device, one or more other devices, or a combination thereof based, at least in part, on a determination of whether the one or more other devices are to be notified of the at least one event.

88. A computer program product of claim 87, wherein the apparatus is caused, at least in part, to further perform:
causing, at least in part, a transmission of at least one ringtone coordination message to the at least one device, the one or more other devices, or a combination thereof,
wherein the at least one ringtone coordination message relates, at least in part, to the coordination of the playback of the at least one ringtone, the determination of whether the one or more other devices are to be notified of the at least one event, or a combination thereof.
